(19) United States
(12) Patent Application Publication
(10) Pub. No.: US 2016/0349987 A1
(43) Pub. Date: Dec. 1, 2016

(54) INPUT METHOD AND INPUT DEVICE

(71) Applicant: ALPS ELECTRIC CO., LTD., Tokyo (JP)

(72) Inventors: Shinya Abe, Miyagi-Ken (JP); Yu Watanabe, Miyagi-ken (JP)

(21) Appl. No.: 15/233,403

(22) Filed: Aug. 10, 2016

Related U.S. Application Data
(63) Continuation of application No. PCT/JP2015/051895, filed on Jan. 23, 2015.

(30) Foreign Application Priority Data
Feb. 14, 2014 (JP) 2014-026740

(51) Int. Cl. G06F 3/0488; G06F 3/0484; G06F 3/0482

(52) U.S. Cl. CPC G06F 3/04883; G06F 3/0482; G06F 3/04845; G06F 2203/04104; G06F 2203/04808; G06F 2203/04108

(57) ABSTRACT

An input method of performing an input manipulation according to information concerning manipulation bodies in contact with or close to a manipulation surface has a step to select a coordinate input mode or function input mode according to the number of manipulation bodies, a step to select a desired function according to a first manipulation associated with the number of manipulation bodies, a step to select a desired item according to a second manipulation associated with an operation of manipulation bodies, a step to establish selection according to a third manipulation associated with an operation of manipulation bodies, and a step to execute an input according to a fourth manipulation associated with an operation of manipulation bodies. In the function input mode, the first, second, third, and fourth manipulations are performed in succession while a plurality of manipulation bodies are kept in contact with or close to the manipulation surface.

### CLAIM OF PRIORITY

This application is a Continuation of International Application No. PCT/JP2015/051895 filed on Jan. 23, 2015, which claims benefit of priority to Japanese Patent Application No. 2014-026740 filed on Feb. 14, 2014. The entire contents of each application noted above are hereby incorporated by reference.

### BACKGROUND

1. Field of the Disclosure

The present disclosure relates to an input method in which a manipulation body brought into contact with or close to a manipulation surface is used and to an input device that uses the input method.

2. Description of the Related Art

Input devices that have come into widespread use as input devices for vehicle-mounted navigation devices, mobile information terminals, tablet personal computers (PCs), and other electronic units are of a type in which an input manipulation can be performed by bringing a manipulation body such as a fingertip into contact with or close to a manipulation surface, as with touch panels and touch pads.

On these input devices, the manipulator can perform an input manipulation such as a coordinate input by bringing a manipulation body into contact with the manipulation surface. A coordinate input is an input method by which coordinates on the display screen of an electronic unit are identified by bringing a manipulation body into contact at a certain position on the manipulation surface and an input associated with the identified coordinates is performed. It is also possible to scroll contents displayed on the display screen in a predetermined direction by moving the manipulation body in a state in which the manipulation body is kept in contact with the manipulation surface.

In an input method proposed in Japanese Unexamined Patent Application Publication No. 2011-3074, a greater variety of input manipulations can be performed on this type of input device by bringing a plurality of manipulation bodies into contact with or close to the manipulation surface. FIG. 8 illustrates an example of the input method disclosed in Japanese Unexamined Patent Application Publication No. 2011-3074. In FIG. 8, a rectangular part indicates the manipulation surface of a touch panel, each open circle indicates the contact coordinates (contact position) at which a finger (manipulation body) is brought into contact with the manipulation surface, and each arrow indicates a direction in which the hand is rotated.

In the input method illustrated in FIG. 8, the user brings a plurality of fingers into contact with the manipulation surface of the touch panel. The user then performs a rotational manipulation (rotational operation) in which the plurality of fingers are moved together in the rotation direction to select contents to be displayed on the screen of a display device (not illustrated).

Again in the input method illustrated in FIG. 8, the area of a polygon formed by linking the contact positions of the plurality of fingers on the manipulation surface is calculated to detect a rotational speed from the movement of each finger during the rotational manipulation. A display switching speed of a switchover of contents to be displayed on the screen is changed according to the calculated area of the polygon and the detected rotational speed.

As described above, in the input method disclosed in Japanese Unexamined Patent Application Publication No. 2011-3074, a variety of input manipulations are achieved by bringing a plurality of fingers into contact with the manipulation surface of a touch panel.

In recent years, there may be cases in which input devices as described above are used as input devices of a plurality of electronic units such as vehicle-mounted navigation devices and vehicle-mounted air conditioners. Since these input devices involve increased numbers of manipulated functions and items, an easy-to-manipulate input method is demanded. An easy-to-manipulate input method is an input method by which a plurality of input manipulations can be performed by an easier manipulation.

In the input method in Japanese Unexamined Patent Application Publication No. 2011-3074, an input method related to improvement of maneuverability as described above is not disclosed. When a plurality of input manipulations are performed in succession in a conventional input method, complex manipulations have been performed; for example, after one manipulation has been performed by bringing a manipulation body into contact with or close to the manipulation surface, the manipulation body is moved away from the manipulation surface to terminate the input manipulation, after which the manipulation body is brought into contact with or close to the manipulation surface again to perform a next input manipulation. This type of input method could not be said to have superior maneuverability.

### SUMMARY

An input method is provided by which information about a manipulation body that has been brought into contact with or close to a manipulation surface is detected and an input manipulation intended for a target unit to which to supply an input is performed according to the detected information. The method has a mode selection step in which one of a coordinate input mode in which coordinates corresponding to the position of the manipulation body are input and a function input mode in which an operation of the manipulation body is used to perform an input manipulation related to a predetermined function is selected according to the number of manipulation bodies that have been brought into contact with or close to the manipulation surface. In a function selection step, a desired function is selected from a plurality of functions according to a first manipulation associated with the number of manipulation bodies that have been brought into contact with or close to the manipulation surface. In an item selection step, a desired item is selected from a plurality of items related to the selected function according to a second manipulation associated with an operation of manipulation bodies. In an establishment step, the selection of a function and item to be manipulated is established according to a third manipulation associated with an operation of manipulation bodies. In an execution step, an input is executed for the selected item according to a fourth manipulation associated with an operation of manipulation bodies. In the function input mode, the first manipulation, second manipulation, third manipulation, and fourth manipulation are performed in succession in a state in which a plurality of manipulation bodies are kept in contact with or close to manipulation surface.

An input device has a manipulation surface that a manipulation body is brought into contact with or close to, a detecting unit that detects the number of manipulation bodies that have been brought into contact with or close to the manipulation surface, the positions of these manipulation bodies, and their movements, and a control unit that transmits input information to a target unit to which to supply an input, according to the information detected by the detecting unit. The control unit transmits the input information in any one of the input methods according to the first to fifth aspects of the embodiment.

The input device structured as described above has: a manipulation surface that a manipulation body is brought into contact with or close to; a detecting unit that detects the number of manipulation bodies that have been brought into contact with or close to the manipulation surface, the positions of these manipulation bodies, and their movements; and a control unit that transmits input information to a target unit to which to supply an input, according to the information detected by the detecting unit. Therefore, input manipulations that use manipulation bodies that have been brought into contact with or close to the manipulation surface are possible. In addition, the control unit transmits input information in any one of the input methods according to the first to fifth aspects of the embodiment. Accordingly, the input device structured as described above is an input device having superior maneuverability in input manipulations.

### BRIEF DESCRIPTION OF THE DRAWINGS

FIGS. 1A and 1B illustrate the structure of an input device in a first embodiment of the present invention;

FIG. 2 illustrates an example of using the input device in FIGS. 1A and 1B;

FIG. 3 illustrates a method, in the first embodiment of the present invention, by which coordinates are input;

FIG. 4 illustrates a method, in the first embodiment of the present invention, by which functions are input;

FIGS. 5A to 5E illustrate operations, in the first embodiment of the present invention, in a function input;

FIG. 6 is a flowchart, in the first embodiment of the present invention, illustrating a procedure for an input manipulation;

FIGS. 7A to 7E illustrate operations, in a second embodiment of the present invention, in a function input; and

FIG. 8 illustrates an input method disclosed in Japanese Unexamined Patent Application Publication No. 2011-3074.

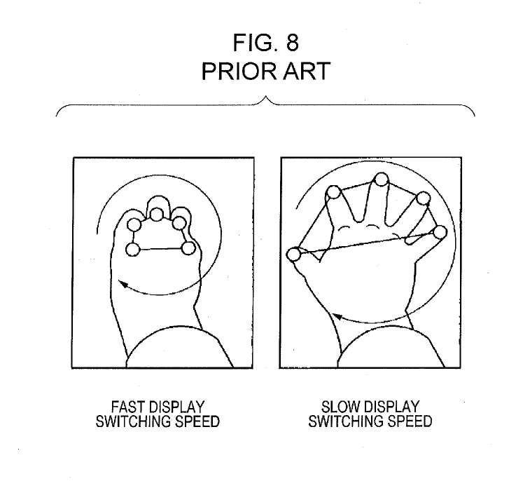

### DESCRIPTION OF THE EXEMPLARY EMBODIMENTS

### First Embodiment

A first embodiment of the present invention will be described with reference to the drawings. In the description below, the X1 direction in each drawing will be taken as the left direction, the X2 direction as the right direction, the Y1 direction as the forward direction, the Y2 direction as the backward direction the Z1 direction as the upward direction, and the Z2 direction as the downward direction.

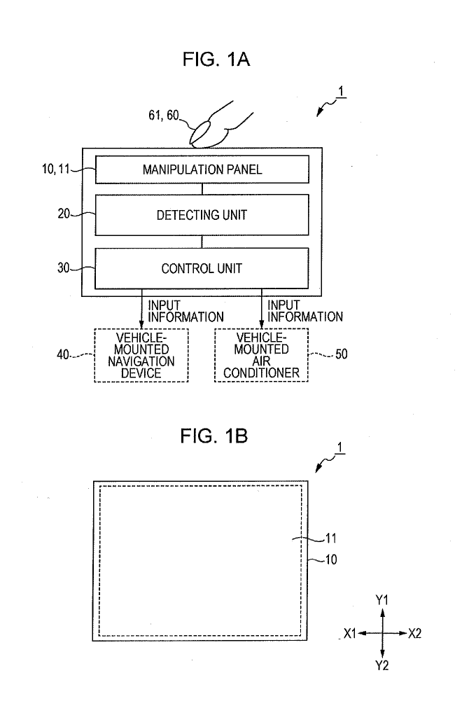

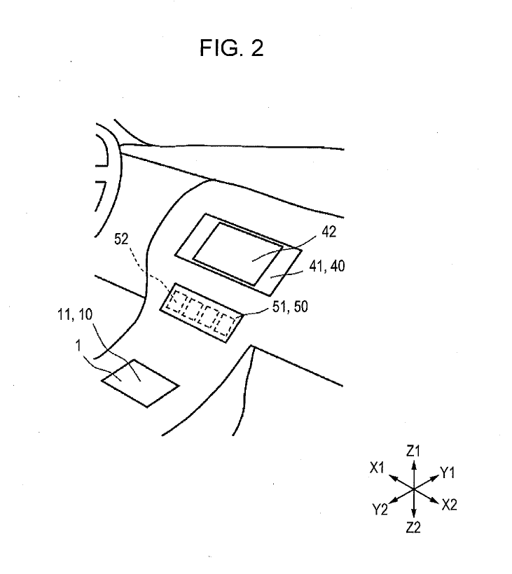

First, the structure of an input device 1 in the first embodiment of the present invention will be descried with reference to FIGS. 1A and 1B and FIG. 2. FIGS. 1A and 1B illustrate the structure of the input device 1 in the first embodiment of the present invention. FIG. 1A is a block diagram illustrating the structure of the input device 1, and FIG. 1B schematically illustrates the manipulation panel 10, of the input device 1, viewed from above. FIG. 2 illustrates an example of using the input device 1 in FIGS. 1A and 1B, illustrating the interior (near a center console) of a vehicle in which the input device 1 is mounted.

The input device 1 is a capacitive touch panel. In addition to the manipulation panel 10, the input device 1 has a detecting unit 20 and a control unit 30 as illustrated in FIG. 1A. The input device 1 is attached in the vicinity of a center console in a vehicle as illustrated in FIG. 2 and is used to perform inputs to a vehicle-mounted navigation device 40, a vehicle-mounted air conditioner 50, and other electronic units.

The manipulation panel 10 is made of a synthetic resin. Its upper surface is in a substantially rectangular shape. A predetermined area on the upper surface of the manipulation panel 10 is a manipulation surface 11 with which a manipulation body 61 of a manipulator 60 is brought into contact. In this embodiment, a fingertip of the manipulator 60 is the manipulation body 61. The manipulator 60 performs an input manipulation by bringing one or a plurality of manipulation bodies 61 into contact with the manipulation surface 11 of the input device 1.

The detecting unit 20 detects the manipulation body 61 that has been brought into contact with the manipulation surface 11. Although the principle of detection by the capacitive touch panel is known and its detailed description will thereby be omitted, an electrode (not illustrated) placed under the manipulation surface 11 is used to detect a capacitance and then the number of manipulation bodies 61 that have been brought into contact with the manipulation surface 11, their positions, and operations are detected according to the detected change in capacitance.

The control unit 30 controls the detecting unit 20. The control unit 30 creates input information according to information detected by the detecting unit 20. The control unit 30 is connected to the vehicle-mounted navigation device 40 and vehicle-mounted air conditioner 50, so the control unit 30 transmits the created input information to the vehicle-mounted navigation device 40 and vehicle-mounted air conditioner 50.

The vehicle-mounted navigation device 40 has a first display device 41, as illustrated in FIG. 2, which is used to display an input screen, a map, and other similar information. A liquid crystal display panel or the like is used as the first display device 41. The first display device 41 is connected to the control unit 30 in the input device 1 through a control unit (not illustrated) in the vehicle-mounted navigation device 40. The vehicle-mounted navigation device 40 displays the contents of an input manipulation on the display screen 42 of the first display device 41 according to the input information transmitted from the control unit 30.

The vehicle-mounted air conditioner 50 has a second display device 51, as illustrated in FIG. 2, which is used to display temperature, the amount of wind, a wind direction, and other similar information. A display part 52 is located at a predetermined position on the second display device 51. On the display part 52, a temperature setting, a setting of the amount of wind, a wind direction setting, an actual temperature, and other similar information are displayed. The second display device 51 is connected to the control unit 30 in the input device 1 through a control unit (not illustrated) in the vehicle-mounted air conditioner 50. Light emitting-elements (not illustrated) such as light-emitting diodes (LEDs) are built into the display part 52. The vehicle-mounted air conditioner 50 turns on or blinks a predetermined position in the display part 52 according to the input information transmitted from the control unit 30. Thus, the contents of an input manipulation are displayed concerning a temperature setting, a setting of the amount of wind, a wind direction setting, and the like.

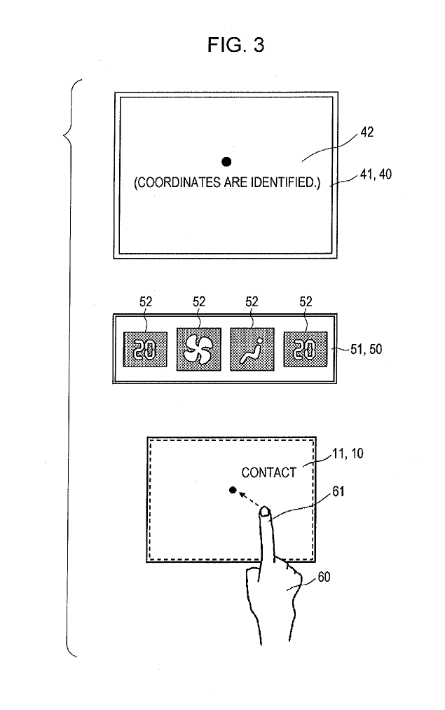

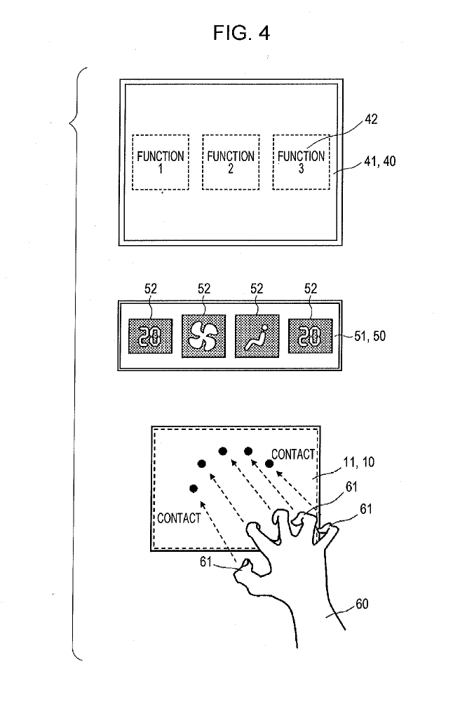

Next, input manipulation methods in which the input device 1 is used will be described with reference to FIGS. 3 and 4. FIG. 3 illustrates a method, in the first embodiment of the present invention, by which coordinates are input. FIG. 4 illustrates a method, in the first embodiment of the present invention, by which functions are input.

The input device 1 supports two modes available during an input manipulation, a coordinate input mode related to a coordinate input and a function input mode related to a function input. A coordinate input is an input method by which coordinates corresponding to the position of the manipulation body 61 brought into contact with the manipulation surface 11 are input. A function input is an input method by an operation of the manipulation body 61 is used to make an input concerning a predetermined function.

In this embodiment, when an input manipulation intended for the vehicle-mounted navigation device 40 is performed, both the coordinate input mode and the function input mode are used. When an input manipulation intended for the vehicle-mounted air conditioner 50 is performed, the function input mode is used. Whether the coordinate input mode or the function input mode is selected depends on the number of manipulation bodies 61 that have brought into contact with the manipulation surface 11. If only one manipulation body 61 has been brought into contact with the manipulation surface 11, the coordinate input mode is preferably selected. If a plurality of manipulation bodies 61 have been brought into contact with the manipulation surface 11, the function input mode is preferably selected.

In the coordinate input mode, one manipulation body 61 (such as the tip of the index finger) is brought into contact with the manipulation surface 11 of the input device 1 to perform an input manipulation. Coordinates on the display screen 42 of the first display device 41 are identified in correspondence to the position, on the manipulation surface 11, at which the manipulation body 61 has been brought into contact (the position will be referred to below as the contact position of the manipulation body 61). If a letter, a numeral, or a function is being displayed at the identified coordinates, the letter, numeral, or function is selected. If a map is being displayed on the display screen 42, a position, on the map, corresponding to the identified coordinates is selected. If the manipulation body 61 is moved in a state in which the manipulation body 61 is kept in contact with the manipulation surface 11, it is also possible to scroll the contents displayed on the display screen 42 in a predetermined direction. The principle and method of this input manipulation in the coordinate input mode are known, so their detailed description will be omitted.

Next, an input manipulation method in the function input mode will be described. In an input manipulation in the function input mode, a desired function and item are selected from a plurality of functions supported by the vehicle-mounted navigation device 40 and vehicle-mounted air conditioner 50 and an input is executed for the selected function and item. Functions supported by the vehicle-mounted navigation device 40 include a function to set a destination, a function to set a display condition such as a map, and a function to set a calculation condition such as an arrival time. Each of these functions has a plurality of setting items, the settings of which can be changed. Functions supported by the vehicle-mounted air conditioner 50 include a function to set an air conditioning condition. The air conditioning condition setting function has a plurality of setting items such as temperature, the amount of wind, and a wind direction.

In the function input mode, a plurality of manipulation bodies 61 (a plurality of fingertips) are brought into contact with the manipulation surface 11 of the input device 1 to perform an input manipulation. In the function input mode, various types of input operations are performed according to the number of manipulation bodies 61 that have been brought into contact with the manipulation surface 11 and their operations.

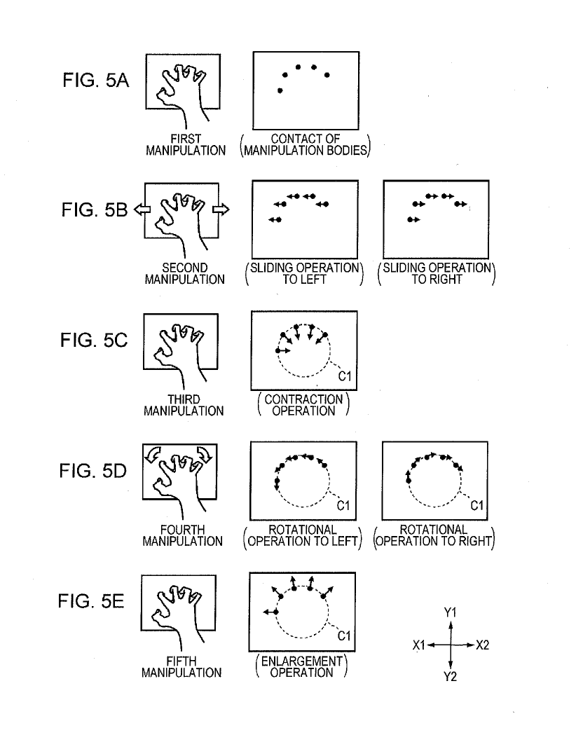

Examples of input manipulations based on the number of manipulation bodies 61 and their operations will be described below with reference to FIGS. 5A to 5E. FIGS. 5A to 5E illustrate operations, in the first embodiment of the present invention, in a function input. Specifically, FIGS. 5A to 5E illustrate various input manipulations in the function input mode and their corresponding operations of the manipulation bodies 61. In FIGS. 5A to 5E, each figure on the left side is a conceptual drawing and each figure at the center and on the right side indicates the contact positions of the manipulation bodies 61 and the direction or directions of their movement during the input manipulation. In FIGS. 5A to 5E, a solid circle indicates the contact position of a manipulation body 61 and an arrow (solid line) indicates a direction in which the relevant manipulation body 61 moves. A dotted circle indicates a virtual circle C1, on the manipulation surface 11, to which each of a plurality of manipulation bodies 61 brought into contact with the manipulation surface 11 are close.

FIG. 5A indicates a first manipulation associated with the number of manipulation bodies 61 that have been brought into contact with the manipulation surface 11. The first manipulation is used to select a desired function from a plurality of functions supported by the vehicle-mounted navigation device 40 and vehicle-mounted air conditioner 50. When the number of manipulation bodies 61 to be brought into contact with the manipulation surface 11 is changed in the range from 2 to 5, a function to be selected is changed according to the number of manipulation bodies 61.

FIG. 5B indicates a second manipulation associated with an operation of manipulation bodies 61. The second manipulation is preferably associated with a slide operation to move a plurality of manipulation bodies 61 together that have been brought into contact with the manipulation surface 11 to the right or left. The second manipulation is used to select a desired item from a plurality of items related to a selected function. An item to be selected is changed according to the direction of the slide operation and the amount of movement.

FIG. 5C indicates a third manipulation associated with an operation of manipulation bodies 61. The third manipulation is preferably associated with a contraction operation to move a plurality of manipulation bodies 61 that have been brought into contact with the manipulation surface 11 toward the center of the plurality of manipulation bodies 61. In this embodiment, the center of the plurality of manipulation bodies 61 is the center of the virtual circle C1. The third manipulation is used to establish a function and item to be manipulated.

FIG. 5D indicates a fourth manipulation associated with an operation of manipulation bodies 61. The fourth manipulation is preferably associated with a rotational operation to move a plurality of manipulation bodies 61 together that have been brought into contact with the manipulation surface 11 along the circumference of the virtual circle C1. The fourth manipulation is used to input a setting corresponding to a selected item. A setting is changed according to the direction of the rotational operation and the amount of movement. In the description below, to input a setting corresponding to the selected item will be simply represented as to execute an input.

FIG. 5E indicates a fifth manipulation associated with an operation of manipulation bodies 61. The fifth manipulation is preferably associated with an enlargement operation to move a plurality of manipulation bodies 61 that have been brought into contact with the manipulation surface 11 in a direction away from the center of the plurality of manipulation bodies 61. In this embodiment, the center of the plurality of manipulation bodies 61 is the center of the virtual circle C1. The fifth manipulation is used to deselect a function to be manipulated and an item.

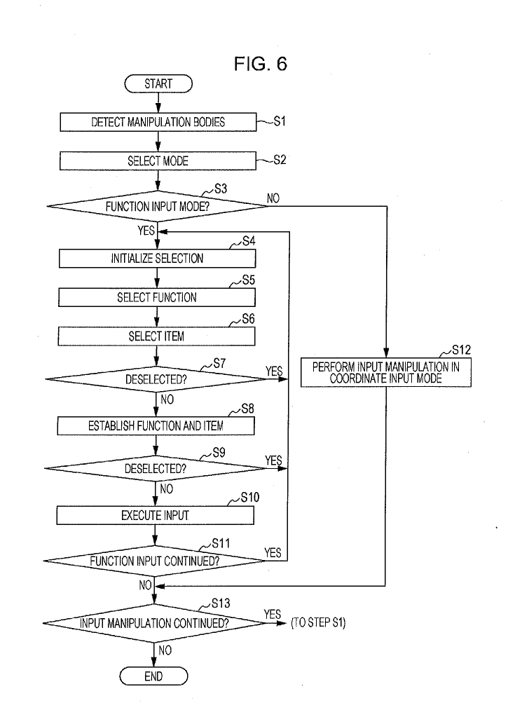

Next, a procedure for an input manipulation in the function input mode will be described with reference to FIG. 6. FIG. 6 is a flowchart, in the first embodiment of the present invention, illustrating a procedure for an input manipulation. Specifically, FIG. 6 illustrates a procedure for selecting a desired function and item from a plurality of functions supported by the vehicle-mounted navigation device 40 and vehicle-mounted air conditioner 50 and executing an input for the selected item.

As illustrated in FIG. 6, the detecting unit 20 in the input device 1 first detects the contacts of manipulation bodies 61 with the manipulation surface 11 (step S1). In step S2, which is a mode selection step, the detecting unit 20 then detects the number of manipulation bodies 61 that have been brought into contact with the manipulation surface 11, and the control unit 30 selects one of the coordinate input mode and function input mode according to the number of manipulation bodies 61 that have been brought into contact with the manipulation surface 11. In step S2, if only one manipulation body 61 is detected as having been brought into contact with the manipulation surface 11, the coordinate input mode is selected; if a plurality of manipulation bodies 61 are detected as having been brought into contact with the manipulation surface 11, the function input mode is selected.

In step S3, the control unit 30 makes a decision as to whether the selected mode is the function input mode. If the selected mode is the function input mode in step S3, the processing proceeds to step S4. The control unit 30 then transmits input information corresponding to the function input mode. If the selected mode is not the function input mode (the selected mode is the coordinate input mode) in step S3, the processing proceeds to step S12.

In step S4, the selection of a function and item to be manipulated is initialized. In step S5, which is a function selection step, a desired function is selected from a plurality of functions supported by the vehicle-mounted navigation device 40 and vehicle-mounted air conditioner 50, according to the first manipulation associated with the number of manipulation bodies 61 that have been brought into contact with the manipulation surface 11. The control unit 30 transmits, to the vehicle-mounted navigation device 40 and vehicle-mounted air conditioner 50, input information based on the number of manipulation bodies 61 that have been brought into contact with the manipulation surface 11. According to the input information transmitted from the control unit 30, the vehicle-mounted navigation device 40 or vehicle-mounted air conditioner 50 selects, from a plurality of functions, a function corresponding to the input information and displays the selected function on the first display device 41 or second display device 51.

In step S6, which is an item selection step, a desired item is selected from a plurality of items concerning the selected function according to the second manipulation associated with an operation of manipulation bodies 61. As described above, the second manipulation is associated with to the slide operation described above. The control unit 30 transmits, to the vehicle-mounted navigation device 40 and vehicle-mounted air conditioner 50, input information based on the direction of the slide operation and the amount of movement. According to the input information transmitted from the control unit 30, the vehicle-mounted navigation device 40 or vehicle-mounted air conditioner 50 selects, from a plurality of items, an item corresponding to the input information and displays the selected item on the first display device 41 or second display device 51.

In step S7, which is a first deselection step, the control unit 30 makes a decision as to whether to deselect the selected function, according to the fifth manipulation associated with an operation of manipulation bodies 61. As described above, the fifth manipulation is associated with the enlargement operation described above. If the fifth manipulation is found in step S7, the processing returns to step S4, in which case, as a result of initialization, the selected function is deselected. If the fifth manipulation is not found in step S7, the processing proceeds to step S8, in which case the selected function is not deselected.

In step S8, which is an establishment step, the function and item are established according to the third manipulation associated with an operation of manipulation bodies 61. As described above, the third manipulation is associated with the contraction operation described above. The control unit 30 transmits input information corresponding to the contraction operation to the vehicle-mounted navigation device 40 and vehicle-mounted air conditioner 50. The vehicle-mounted navigation device 40 or vehicle-mounted air conditioner 50 establishes the selection of the function and item according to the input information transmitted from the control unit 30 and displays, on the first display device 41 or second display device 51, information indicating that the selection of the function and item has been established.

In step S9, which is a second deselection step, the control unit 30 makes a decision as to whether to deselect the selected function, according to the fifth manipulation associated with an operation of manipulation bodies 61. If the fifth manipulation is found in step S9, the processing returns to step S4, in which case, as a result of initialization, the selected function and item are deselected. If the fifth manipulation is not found in step S9, the processing proceeds to step S10, in which case the selected function and item remain selected.

In step S10, which is an execution step, an input is executed for the selected item, according to the fourth manipulation associated with an operation of manipulation bodies 61. As described above, the fourth manipulation is associated with the rotational operation described above. The control unit 30 transmits, to the vehicle-mounted navigation device 40 and vehicle-mounted air conditioner 50, input information based on the direction of the rotational operation and the amount of movement. The vehicle-mounted navigation device 40 or vehicle-mounted air conditioner 50 changes the setting concerning the selected item according to the input information transmitted from the control unit 30 and displays a new setting on the first display device 41 or second display device 51.

In step S11, the control unit 30 makes a decision as to whether to continue the input manipulation being performed in the function input mode. If a plurality of manipulation bodies 61 are kept in contact with the manipulation surface 11 in step S11, the processing returns to step S4, in which case the input manipulation in the function input mode is continued. If a plurality of manipulation bodies 61 are not kept in contact with the manipulation surface 11 in step S11 (only at least one of the plurality of manipulation bodies 61 is kept in contact with the manipulation surface 11), the processing proceeds to step S13, in which case the input manipulation in the function input mode is terminated.

In step S12, an input manipulation in the coordinate input mode is performed in response to the negative result in step S3. A procedure for an input manipulation in the coordinate input mode is known, so its detailed description will be omitted. If the input manipulation in the coordinate input mode is terminated in step S12, the processing proceeds to step S13.

In step S13, the control unit 30 makes a decision as to whether to continue the input manipulation. If it is decided in step S13 that the manipulation bodies 61 are kept in contact with the manipulation surface 11, the processing returns to step S1, in which case the input manipulation in the function input mode or coordinate input mode is continued. At that time, if the function input mode is selected again, the previous selection may be continued without selection initialization in step S4 being performed. If it is decided in step S13 that manipulation bodies 61 are not kept in contact with the manipulation surface 11 (there is no manipulation body 61 kept in contact with the manipulation surface 11), the input manipulation is terminated.

In the input device 1, an input manipulation in the function input mode or coordinate input mode is performed according the procedure described above. In the function input mode, the first manipulation, second manipulation, third manipulation, and fourth manipulation are performed in succession in a state in which a plurality of manipulation bodies 61 are kept in contact with the manipulation surface 11.

Next, effects in this embodiment will be described. The input method in this embodiment has a mode selection step in which one of the coordinate input mode and function input mode is selected according to the number of manipulation bodies 61 that have been brought into contact with the manipulation surface 11 and a function selection step in which a desired function is selected from a plurality of functions according to the first manipulation associated with the number of manipulation bodies 61 that have been brought into contact with the manipulation surface 11; the input method uses a plurality of manipulation bodies 61 that are brought into contact with the manipulation surface 11. In addition, a mode and a function can be selected by a simple manipulation; it is only necessary to change the number of manipulation bodies 61 to be brought into contact with the manipulation surface 11.

The input method in this embodiment further has an item selection step in which a desired item is selected from a plurality of items concerning the selected function according to the second manipulation associated with an operation of manipulation bodies 61, an establishment step in which the selection of a function and item to be manipulated is established according to the third manipulation associated with an operation of manipulation bodies 61, and an execution step in which an input of the selected item is executed according to the fourth manipulation associated with an operation of manipulation bodies 61. In the function input mode, the first manipulation, second manipulation, third manipulation, and fourth manipulation are performed in succession in a state in which a plurality of manipulation bodies 61 are kept in contact with the manipulation surface 11. Since the first manipulation, second manipulation, third manipulation, and fourth manipulation are performed as a series of operation as described above, operations for input manipulations can be simplified. As a result, the input method in this embodiment can improve maneuverability in input manipulations.

In the input method in this embodiment, if, in the mode selection step, only one manipulation body 61 has been brought into contact with the manipulation surface 11, the coordinate input mode is preferably selected; if a plurality of manipulation bodies 61 have been brought into contact with the manipulation surface 11, the function input mode is preferably selected. In the coordinate input mode, when only one manipulation body 61 has been brought into contact with the manipulation surface 11, the position of the manipulation body 61 and its corresponding coordinates can be more easily identified. In the function input mode, when a plurality of manipulation bodies 61 have been brought into contact with the manipulation surface 11, operations of the manipulation bodies 61 and their corresponding input manipulations can be more easily diversified. In the input method in this embodiment, therefore, input manipulations after a mode has been selected can be smoothly performed.

In the input method in this embodiment, the second manipulation is preferably associated with a slide operation to move a plurality of manipulation bodies 61 together that have been brought into contact with the manipulation surface 11 to the right or left. The fourth manipulation is preferably associated with a rotational operation to move a plurality of manipulation bodies 61 together that have been brought into contact with the manipulation surface 11 along a circumference. In this slide operation and rotational operation, a distance between manipulation bodies 61 does not change. The third manipulation is preferably associated with a contraction operation to move a plurality of manipulation bodies 61 that have been brought into contact with the manipulation surface 11 toward the center of the plurality of manipulation bodies 61. In this contraction operation, a distance between manipulation bodies 61 is shortened. Therefore, whether the manipulation is the second manipulation or third manipulation can be identified depending on whether a distance between manipulation bodies 61 has changed, so a distinction between the second manipulation and the third manipulation can be easily identified. Similarly, a distinction between the third manipulation and the fourth manipulation can be easily identified. As a result, the input method in this embodiment can enhance the reliability of input manipulations.

In the input method in this embodiment, if the fifth manipulation is performed after the third manipulation or fourth manipulation has been performed, it is possible to shift to a deselection step and cancel the selection of a function and item to be manipulated. Therefore, after the current input manipulation has been suspended, a shift to a next input manipulation can be easily made. In addition, the fifth manipulation is preferably associated with an enlargement operation to move a plurality of manipulation bodies 61 that have been brought into contact with the manipulation surface 11 in a direction away from the center of the plurality of manipulation bodies 61. Therefore, the directions in which the manipulation bodies 61 move are reversed between the third manipulation and the fifth manipulation, enabling a distinction between the third manipulation and the fifth manipulation to be easily indentified. It is also possible to identify whether the manipulation is the fourth manipulation or fifth manipulation depending on whether a distance between manipulation bodies 61 has changed, so a distinction between the fourth manipulation and the fifth manipulation can be easily identified. As a result, the input method in this embodiment can further improve maneuverability and can further enhance the reliability of input manipulations.

The input device 1 in this embodiment has the manipulation surface 11 with which manipulation bodies 61 are brought into contact, the detecting unit 20 that detects the number of manipulation bodies 61 that have been brought into contact with the manipulation surface 11, the positions of these manipulation bodies 61, and their movements, and the control unit 30 that transmits input information to the vehicle-mounted navigation device 40 and vehicle-mounted air conditioner 50, which are target units to which to supply inputs, according to the information detected by the detecting unit 20. Therefore, input manipulations that use manipulation bodies 61 that have been brought into contact with the manipulation surface 11 are possible. In addition, the control unit 30 transmits input information in the input method described above. Accordingly, the input device 1 in this embodiment is an input device having superior maneuverability in input manipulations.

In the input device 1 in this embodiment, the control unit 30 is preferably connected to the first display device 41 through a control unit in the vehicle-mounted navigation device 40. The control unit 30 is also preferably connected to the second display device 51 through a control unit in the vehicle-mounted air conditioner 50. As described above, the first display device 41 of the vehicle-mounted navigation device 40 and the second display device 51 of the vehicle-mounted air conditioner 50 can preferably display the contents of an input manipulation in the function input mode. Therefore, the input device 1 enables the manipulator to perform an input manipulation while checking the contents of the input manipulation in the function input mode. As a result, the input device 1 in this embodiment can enhance the reliability of input manipulations.

### Second Embodiment

A second embodiment of the present invention will be described with reference to the drawings. In this embodiment, the same elements as in the first embodiment will be given the same reference numerals and their detail descriptions will be omitted.

In this embodiment, the structures of the input device 1, vehicle-mounted navigation device 40, and vehicle-mounted air conditioner 50 are the same as in the first embodiment. However, an input manipulation method in this embodiment differs from the first embodiment. In this embodiment, an input manipulation method in the function input mode and its effects will be described.

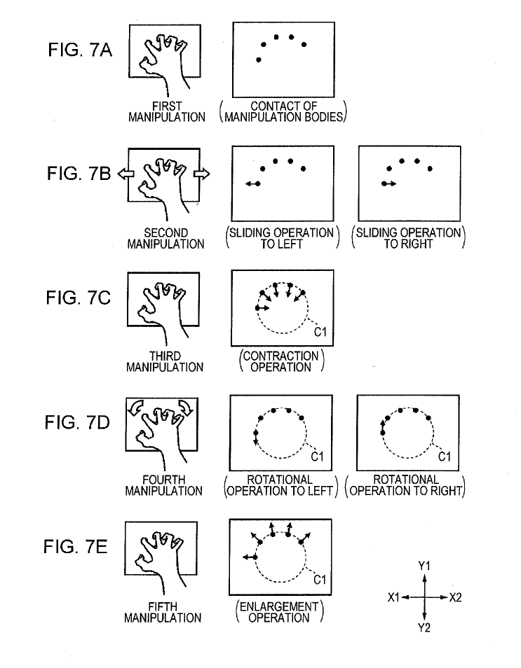

First, the input manipulation method in the function input mode will be described with reference to FIGS. 7A to 7E. FIGS. 7A to 7E illustrate operations, in the second embodiment of the present invention, in a function input. In FIGS. 7A to 7E, the operation associated with the first manipulation, the operation associated with the third manipulation, and the operation associated with the fifth manipulation are the same as the relevant operation in FIGS. 5A, 5C, and 5E, but the operation associated with the second manipulation and the operation associated with the fourth manipulation differ from the operations in FIGS. 5B and 5D.

The second manipulation is preferably associated with a slide operation to move one (such as the tip of a thumb) of a plurality of manipulation bodies 61 to the right or left while the plurality of manipulation bodies 61 are kept in contact with the manipulation surface 11, as illustrated in FIG. 7B. The fourth manipulation is preferably associated with a rotational operation to move one (such as the tip of a thumb) of a plurality of manipulation bodies 61 along the circumference of the virtual circle C1 while the plurality of manipulation bodies 61 are kept in contact with the manipulation surface 11, as illustrated in FIG. 7D.

A procedure for an input manipulation in this embodiment is the same as the procedure in the first embodiment, except that the second manipulation in step S6 is not associated with the slide operation in FIG. 5B but is associated with the slide operation in FIG. 7B and that the fourth manipulation in step S10 is not associated with the rotational operation in FIG. 5D but is associated with the rotational operation in FIG. 7D.

Next, effects in this embodiment will be described. In the input method in this embodiment, the second manipulation is preferably associated with a slide operation to move any one of a plurality of manipulation bodies 61 in a predetermined direction. The third manipulation is preferably associated with a contraction operation to move all of a plurality of manipulation bodies 61 toward the center of the plurality of manipulation bodies 61. The fourth manipulation is preferably associated with a rotational operation to move any one of a plurality of manipulation bodies 61 along a circumference. As described above, the second manipulation and fourth manipulation are associated with an operation to move only one manipulation body 61, so the operation can be simplified when compared with an operation to move a plurality of manipulation bodies 61. As a result, the input method in this embodiment can further improve maneuverability in input manipulations when compared with the input method in the first embodiment.

In addition, although the second manipulation and fourth manipulation are associated with an operation to move only one manipulation body 61, the third manipulation is associated with an operation to move a plurality of manipulation bodies 61. Therefore, whether the manipulation is the second manipulation or third manipulation can be identified depending on whether only one manipulation body 61 or a plurality of manipulation bodies 61 have been moved, so a distinction between the second manipulation and the third manipulation can be easily identified. Similarly, a distinction between the third manipulation and the fourth manipulation can be easily identified. As a result, the input method in this embodiment can enhance the reliability of input manipulations as in the input method in the first embodiment.

So far, embodiments of the present invention have been described. However, the present invention is not limited to these embodiments. The present invention can be appropriately modified without departing from the range of objects of the present invention.

In the embodiments of the present invention, the input device 1, for example, may be connected to an electronic unit other than described above, such as a game machine, a mobile information terminal, a personal computer (PC), or a business-oriented unit. Only one electronic unit may be connected to the input device 1 or three or more electronic units may be connected to the input device 1. The vehicle-mounted navigation device 40 and vehicle-mounted air conditioner 50 may further have another input means other than the input device 1. The input device 1 and the other input means may be combined to perform a manipulation of an input to the vehicle-mounted navigation device 40 or vehicle-mounted air conditioner 50.

In the embodiments of the present invention, the input device 1 may be an input device other than a capacitive input device, such as a resistive film touch panel or infrared touch panel. The input device 1 may detect manipulation bodies 61 close to the manipulation surface 11 instead of manipulation bodies 61 that have been brought into contact with the manipulation surface 11. Alternatively, the input device 1 may detect both manipulation bodies 61 that have been brought into contact with the manipulation surface 11 and manipulation bodies 61 close to the manipulation surface 11.

In the embodiments of the present invention, the manipulation surface 11 of the manipulation panel 10 may have a non-rectangular shape. For example, the manipulation surface 11 may be circular or elliptical or may be a curved surface in a semispherical shape. The orientation of the manipulation surface 11 may be appropriately changed to match the standard of the electronic unit to be used and its usage state.

In the embodiments of the present invention, the second manipulation may be associated with a slide operation to move manipulation bodies 61 in the forward or backward directions instead of the slide operation to move manipulation bodies 61 to the right or left. Alternatively, the second manipulation may be associated with a rotational operation instead of the slide operation. The fourth manipulation may be associated with a slide operation instead of the rotational operation.

In the embodiments of the present invention, the center of a plurality of manipulation bodies 61 in the third manipulation and fifth manipulation may not be the center of the virtual circle C1 described above. For example, the center of a plurality of manipulation bodies 61 may be the center of gravity of a polygon formed by linking positions at which a plurality of manipulation bodies 61 are brought into contact with the manipulation surface 11. In the third manipulation and fifth manipulation, all of a plurality of manipulation bodies 61 do not need to be moved. If three or more manipulation bodies 61 have been brought into contact with the manipulation surface 11, only two of the manipulation bodies 61 may be moved.

In the embodiments of the present invention, the procedure for an input manipulation may be other than described above. For example, in the procedure for an input manipulation illustrated in FIG. 6, mode selection in step S2 and function selection in step S5 may be concurrently performed according to the number of manipulation bodies 61 that have been brought into contact with the manipulation surface 11. Alternatively, a third deselection step may be added between step S5, which is a function selection step, and step S6, which is an item selection step. In a procedure from step S4, which is a function selection step, to step S10, which is an execution step, if a manipulation body 61 is temporarily separated from the manipulation surface 11 but is brought into contact with manipulation surface 11 again within a predetermined time, the function input mode may be kept. During an input manipulation in the coordinate input mode or an input manipulation in the function input mode, a switchover to the other input mode may be made at any time by changing the number of manipulation bodies 61 during the input manipulation. During the switchover, selected information in the function input mode may be retained.

What is claimed is:

1. An input method by which information about a manipulation body that has been brought into contact with or close to a manipulation surface is detected and an input manipulation intended for a target unit to which to supply an input is performed according to the detected information, the method comprising: selecting a mode selection from one of a coordinate input mode in which a coordinate corresponding to a position of the manipulation body is input and a function input mode in which an operation of the manipulation body is used to perform an input manipulation related to a predetermined function according to the number of manipulation bodies that have been brought into contact with or close to the manipulation surface; selecting a desired function from a plurality of functions according to a first manipulation associated with the number of manipulation bodies that have been brought into contact with or close to the manipulation surface; selecting a desired item is selected from a plurality of items related to the selected function according to a second manipulation associated with an operation of the manipulation body; establishing a selection of a function and an item to be manipulated according to a third manipulation associated with an operation of the manipulation body; and executing an input for the selected item according to a fourth manipulation associated with an operation of the manipulation body; wherein in the function input mode, the first manipulation, the second manipulation, the third manipulation, and the fourth manipulation are performed in succession in a state in which a plurality of manipulation bodies are kept in contact with or close to the manipulation surface.

2. The input method according to claim 1, wherein, in selecting a mode: if only one manipulation body has been brought into contact with or close to the manipulation surface, the coordinate input mode is selected, and if a plurality of manipulation bodies have been brought into contact with or close to the manipulation surface, the function input mode is selected.

3. The input method according to claim 2, wherein: the second manipulation is associated with a slide operation to move a plurality of manipulation bodies together that have been brought into contact with or close to the manipulation surface in a predetermined direction or with a rotational operation to move the plurality of manipulation bodies together along a circumference, the third manipulation is associated with a contraction operation to move a plurality of manipulation bodies that have been brought into contact with or close to the manipulation surface toward a center of the plurality of manipulation bodies; and the fourth manipulation is associated with a slide operation to move a plurality of manipulation bodies together that have been brought into contact with or close to the manipulation surface in a predetermined direction or with a rotational operation to move the plurality of manipulation bodies together along a circumference.

4. The input method according to claim 2, wherein:
the second manipulation is associated with a slide operation to move any one of a plurality of manipulation bodies that have been brought into contact with or close to the manipulation surface in a predetermined direction or with a rotational operation to move the one of the plurality of manipulation bodies along a circumference;
the third manipulation is associated with a contraction operation to move all of a plurality of manipulation bodies that have been brought into contact with or close to the manipulation surface toward a center of the plurality of manipulation bodies; and
the fourth manipulation is associated with a slide operation to move any one of a plurality of manipulation bodies that have been brought into contact with or close to the manipulation surface in a predetermined direction or with a rotational operation to move the one of the plurality of manipulation bodies along a circumference.

5. The input method according to claim 3, further comprising deselecting a selection of a function and an item to be manipulated according to a fifth manipulation associated with an operation of the manipulation body, wherein:
the fifth manipulation is associated with an enlargement operation to move a plurality of manipulation bodies that have been brought into contact with or close to the manipulation surface in a direction away from a center of the plurality of manipulation bodies, and
if the fifth manipulation is performed after the third manipulation or the fourth manipulation has been performed, a shift to deselecting.

6. An input device comprising:
a manipulation surface that a manipulation body is brought into contact with or close to;
a detector that detects the number of manipulation bodies that have been brought into contact with or close to the manipulation surface, a position of a manipulation body, and an movement of the manipulation body; and
a controller that transmits input information to a target unit to which to supply an input, according to information detected by the detecting unit; wherein the controller transmits the input information is input by:
selecting a mode selection from one of a coordinate input mode in which a coordinate corresponding to a position of the manipulation body is input and a function input mode in which an operation of the manipulation body is used to perform an input manipulation related to a predetermined function according to the number of manipulation bodies that have been brought into contact with or close to the manipulation surface;
selecting a desired function from a plurality of functions according to a first manipulation associated with the number of manipulation bodies that have been brought into contact with or close to the manipulation surface;
selecting a desired item is selected from a plurality of items related to the selected function according to a second manipulation associated with an operation of the manipulation body;
establishing a selection of a function and an item to be manipulated according to a third manipulation associated with an operation of the manipulation body; and
executing an input for the selected item according to a fourth manipulation associated with an operation of the manipulation body; wherein
in the function input mode, the first manipulation, the second manipulation, the third manipulation, and the fourth manipulation are performed in succession in a state in which a plurality of manipulation bodies are kept in contact with or close to the manipulation surface.

7. The input device according to claim 6, wherein the input device is connected to a display on which contents of an input manipulation in the function input mode are displayed.
